(19) United States
(12) Patent Application Publication
(10) Pub. No.: US 2026/0320316 A1
(43) Pub. Date: Oct. 15, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Taekjung KWON, Suwon-si (KR); Yongkyoung SONG, Suwon-si (KR); Taehyun KIM, Suwon-si (KR)

(73) Assignee: SAMSUNG ELECTRONICS CO., LTD., Suwon-si (KR)

(21) Appl. No.: 19/571,198

(22) Filed: Mar. 18, 2026

Related U.S. Application Data
(63) Continuation of application No. PCT/KR2026/001837, filed on Jan. 30, 2026.

(30) Foreign Application Priority Data
Jan. 31, 2025 (KR) 10-2025-0012672

(51) Int. Cl. G06F 40/58

(52) U.S. Cl. CPC G06F 40/58

(57) ABSTRACT

An electronic apparatus includes a memory to store instructions and at least one processor to collectively or individually execute the instructions to cause the electronic apparatus to obtain a first token corresponding to a text of an input in a first language, update a window corresponding to the first language where the first token is stored based on a length of the first token, obtain a second token of a second language through an artificial intelligence model based on a plurality of tokens stored in a window corresponding to the updated window corresponding to the first language, and based on at least one token included in the obtained second token of the second language, which corresponds to a plurality of tokens pre-stored in a window corresponding to the second language, update a window corresponding to the second language based on the at least one token.

### CROSS-REFERENCE TO RELATED APPLICATION

This application is a continuation application, under 35 U.S.C. § 111 (a), of international application No. PCT/KR2026/001837, filed Jan. 30, 2026, which claims priority under 35 U. S. C. § 119 to Korean Patent Application No. 10-2025-0012672, filed Jan. 31, 2025, the disclosures of which are incorporated herein by reference in their entireties.

### BACKGROUND

### Field

The present disclosure relates to an electronic apparatus and a controlling method thereof, and more particularly, to an electronic apparatus for improving translation accuracy and a controlling method thereof.

### Description of Related Art

Recently, with the development of electronic technology, users have been able to receive translation services through electronic apparatuses.

However, in the related art, there is a problem of translation delay since translation begins only after identifying the end of a sentence.

Accordingly, there is a demand for exploring a method of translating source language text in real time.

### SUMMARY

An electronic apparatus according to an embodiment includes a memory to store instructions and at least one processor to collectively or individually execute the instructions to cause the electronic apparatus to obtain a first token corresponding to a text of an input first language, update a window corresponding to the first language where the first token is stored based on a length of the first token, obtain a second token of a second language through an artificial intelligence model based on a plurality of tokens stored in a window corresponding to the updated window corresponding to the first language, and based on at least one token included in the obtained second token of the second language, which corresponds to a plurality of tokens pre-stored in a window corresponding to the second language, update a window corresponding to the second language based on the at least one token.

The instructions, when executed by the at least one processor collectively or individually, may cause the electronic apparatus to store the obtained first token in a first buffer, and update the window corresponding to the first language, which identifies a number of stored tokens according to the first language, based on a number of tokens included in the first token.

The first token is among a plurality of tokens of the first language and the instructions, when executed by the at least one processor collectively or individually, may cause the electronic apparatus to, based on a length of the first token being longer than a length of the window corresponding to the first language, update the window corresponding to the first language by storing a portion of tokens included in the first token in the window.

The first token is among a plurality of tokens of the first language and the instructions, when executed by the at least one processor collectively or individually, may cause the electronic apparatus to remove a front portion of the plurality of tokens of the first language, and update the window corresponding to the first language by storing added tokens among a plurality of tokens stored in the window corresponding to the first language.

The second token is among a plurality of tokens of the second language and the instructions, when executed by the at least one processor collectively or individually, may cause the electronic apparatus to store a second token of the second language in a second buffer, and identify whether the plurality of tokens of the second language correspond to a plurality of tokens stored in a window corresponding to the second language no less than a preset number of times.

The instructions, when executed by the at least one processor collectively or individually, may cause the electronic apparatus to store at least one token included in the plurality of tokens of the second language in a third buffer.

The second token is among a plurality of tokens of the second language and the instructions, when executed by the at least one processor collectively or individually, may cause the electronic apparatus to, based on a length of the second token of the second language being longer than a length of a window corresponding to the second language, update the window by removing a token with a high priority among a plurality of tokens of the second language.

The window corresponding to the second language may store a plurality of tokens stored in the second buffer and a third buffer where at least one token among the plurality of tokens of the second language is stored.

The instructions, when executed by the at least one processor collectively or individually, may cause the electronic apparatus to set a length of a window corresponding to the first language based on the first language, and set a length of a window corresponding to the second language based on the second language.

The instructions, when executed by the at least one processor collectively or individually, may cause the electronic apparatus to, based on there being at least one token included in the obtained second token of the second language, which corresponds to a plurality of tokens pre-stored in a window corresponding to the second language, confirm the at least one token, and update the window corresponding to the second language including the confirmed at least one token.

A method of controlling an electronic apparatus according to an embodiment includes obtaining a first token corresponding to a text of an input in a first language, updating a window corresponding to the first language where the first token is stored based on a length of the first token, obtaining a second token of a second language through an artificial intelligence model based on a plurality of tokens stored in a window corresponding to the updated window corresponding to the first language, and based on at least one token included in the obtained second token of the second language, which corresponds to a plurality of tokens pre-stored in a window corresponding to the second language, updating a window corresponding to the second language based on the at least one token.

The method may include storing the obtained first token in a first buffer, and updating the window corresponding to the first language, which identifies a number of stored tokens according to the first language, based on a number of tokens included in the first token.

The method may include, based on a length of the first token being longer than a length of a window corresponding to the first language, updating the window corresponding to the first language by storing a portion of tokens included in the first token in a window corresponding to the first language.

The first token is among a plurality of tokens of the first language and the method may include removing a front portion of the plurality of tokens of the first language; and updating the window corresponding to the first language by storing added tokens among a plurality of tokens stored in a window corresponding to the first language.

The second token is among a plurality of tokens of the second language and the method may include storing a second token of the second language in a second buffer, and identifying whether the plurality of tokens of the second language correspond to a plurality of tokens stored in a window corresponding to the second language no less than a preset number of times.

The method may include storing at least one token included in the obtained second token of the second language in a third buffer.

The method may include, based on a length of the second token of the second language being longer than a length of a window corresponding to the second language, updating the window by removing a token with a high priority among a plurality of tokens included in the second token.

The window corresponding to the second language may store a plurality of tokens stored in the second buffer and a third buffer where at least one token included in the obtained second token of the second language is stored.

The method may include setting a length of a window corresponding to the first language based on the first language, and setting a length of a window corresponding to the second language based on the second language.

In a non-transitory computer-readable recording medium including a program that executes a method of controlling an electronic apparatus according to an embodiment, the method includes obtaining a first token corresponding to a text of an input in a first language, updating a window corresponding to the first language where the first token is stored based on a length of the first token, obtaining a second token of a second language through an artificial intelligence model based on a plurality of tokens stored in a window corresponding to the updated window corresponding to the first language, and based on at least one token included in the obtained second token of the second language, which corresponds to a plurality of tokens pre-stored in a window corresponding to the second language, updating a window corresponding to the second language based on the at least one token.

### BRIEF DESCRIPTION OF THE DRAWINGS

FIG. 1 is a view provided to explain an embodiment of an electronic apparatus according to an embodiment;

FIG. 2 is a block diagram provided to explain an electronic apparatus according to an embodiment;

FIGS. 3, 4, 5, 6, 7 and 8 are views provided to explain a method of updating a window corresponding to a source language and a second language and performing translation in real time according to an embodiment; and

FIG. 9 is a flowchart provided to explain a method of controlling an electronic apparatus according to an embodiment.

### DETAILED DESCRIPTION

The embodiments of the present disclosure may be modified in various ways, and may have various embodiments, so specific embodiments are illustrated in the drawings and described in detail in the detailed description. However, it is to be understood that the disclosure is not limited to specific exemplary embodiments, but include all modifications, equivalents, and/or alternatives according to exemplary embodiments of the disclosure. Throughout the description of the accompanying drawings, similar components may be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following exemplary embodiments may be modified in several different forms, and the scope of the technical spirit of the disclosure is not limited to the following exemplary embodiments. Rather, these exemplary embodiments make the disclosure thorough and complete, and are provided to completely transfer the spirit of the disclosure to those skilled in the art.

Terms used in the disclosure are used only to describe specific exemplary embodiments rather than limiting the scope of the disclosure. Singular forms are intended to include plural forms unless the context clearly indicates otherwise.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

On the other hand, when an element (e.g., a first element) is referred to as being “directly coupled with/to” or “directly connected to” another element (e.g., a second element), it should be understood that there is no intervening element (e.g., a third element) in-between.

An expression “~configured (or set) to” used in the disclosure may be replaced by an expression, for example, “suitable for,” “having the capacity to,” “~designed to,” “~adapted to,” “~made to,” or “~capable of” depending on a situation. A term “~configured (or set) to” may not necessarily mean “specifically designed to” in hardware.

Instead, an expression “~an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

In exemplary embodiments, a ‘module’ or a ‘unit’ may perform at least one function or operation, and be implemented as hardware or software or be implemented as a combination of hardware and software. In addition, a plurality of ‘modules’ or a plurality of ‘units’ may be integrated into at least one module and be implemented as at least one processor except for a ‘module’ or a ‘unit’ that needs to be implemented as specific hardware.

Meanwhile, various elements and regions in the drawings are schematically drawn in the drawings. Therefore, the technical concept of the disclosure is not limited by a relative size or spacing drawn in the accompanying drawings.

Hereinafter, various embodiments of the present disclosure will be described in detail with reference to accompanying drawings.

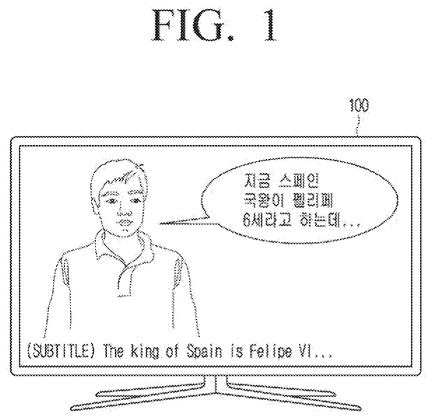

FIG. 1 is a view provided to explain an embodiment of an electronic apparatus according to an embodiment. An electronic apparatus 100, as shown in FIG. 1, may be implemented as a TV. However, this is merely one embodiment, and the electronic apparatus 100 may also be implemented as various types of electronic apparatuses such as a tablet, a laptop computer, a smartphone, a camera, or a PC.

Meanwhile, for convenience of explanation, the following description assumes that the electronic apparatus 100 includes a display (not shown), but this is merely one embodiment, and the electronic apparatus 100 may not include a display and may instead output image data or audio signals via HDMI or DP (Display Port).

In cases where the electronic apparatus 100 does not include a display, the electronic apparatus 100 may transmit data to an external apparatus that includes a display, and the external apparatus may output the image data or audio signals.

First, the electronic apparatus 100 may receive image data. In this case, the image data may include scene data, subtitle data (or text data), and audio data.

There may be an embodiment in which the electronic apparatus 100 performs an operation corresponding to a user voice signal received through a microphone (not shown).

According to an embodiment, the electronic apparatus 100 may control a display 130 based on a user voice signal obtained via a microphone (not shown). For example, when a user voice signal requesting the display of content A is received, the electronic apparatus 100 may control the display 130 to display content A.

According to an embodiment, the electronic apparatus 100 may control an external display apparatus connected thereto based on a user voice signal received through a microphone (not shown). The electronic apparatus 100 may generate a control signal for controlling the external display apparatus so that an operation corresponding to the user voice signal is performed in the external display apparatus, and may transmit the generated control signal to the external display apparatus. The electronic apparatus 100 may store a remote control application for controlling the external display apparatus. Also, the electronic apparatus 100 may transmit the generated control signal to the external display apparatus using at least one of Bluetooth, Wi-Fi, or infrared communication methods. For example, when a user voice signal requesting the display of content A is received, the electronic apparatus 100 may transmit a control signal to the external display apparatus so that content A is displayed on the external display apparatus. The electronic apparatus 100 may refer to various terminal devices capable of installing remote control applications, such as smartphones, AI speakers, etc.

According to an embodiment, the electronic apparatus 100 may use a remote control device to control an external display apparatus connected thereto based on a user voice signal received through a microphone (not shown). The electronic apparatus 100 may transmit a control signal for controlling the external display apparatus to the remote control device so that an operation corresponding to the user voice signal is performed in the external display apparatus. Also, the remote control device may transmit the control signal received from the electronic apparatus 100 to the external display apparatus.

In the present disclosure, a method of real-time translation using a window corresponding to a first language storing data of the first language and a window corresponding to a second language storing data of the second language will be described later.

Meanwhile, for convenience of explanation, the language of text data (subtitle text data) included in the image data obtained by the electronic apparatus 100 will be defined as the “first language,” and the target language as the “second language.”

As shown in FIG. 1, the electronic apparatus 100 may obtain first text and audio data in the first language (e.g., Korean), such as “ [symbol] . . . ”.

In this case, the electronic apparatus 100 may obtain a first token corresponding to the first text, “ [symbol] . . . ”.

The term “token” may refer to a unit obtained by dividing text data into smaller units. For convenience of explanation in this disclosure, a “token” will be described as a “word” unit that constitutes text data, but this is merely one embodiment, and it may also be a sub-word (a smaller unit constituting a word) or a character. In this case, the electronic apparatus 100 may divide the text data into small units and represent a token as an integer.

For example, the first token may be represented by integer values such as [23525, 45647, 23423, 456232, 5452]. The electronic apparatus 100 may store the first token in a first buffer. The first buffer may store tokens converted from text in the first language.

In this case, the electronic apparatus 100 may store the first token in a window corresponding to the first language. The “window corresponding to the first language” may be a token, among the first token, to be input into a translation model.

The electronic apparatus 100 may identify that the length of the window corresponding to the first language is shorter than the length of a plurality of tokens corresponding to “ [symbol] . . . ”. In this case, when the first token is stored in the window corresponding to the first language, the electronic apparatus 100 may delete a front portion of tokens among a plurality of tokens included in the first token.

Meanwhile, when the electronic apparatus 100 updates the window corresponding to the first language, it will be described below under the assumption that one token at the very front among the plurality of tokens included in the first token is deleted; however, this is merely one embodiment, and it is of course possible to delete two or more tokens, such as two or three.

The electronic apparatus 100 may input a plurality of tokens stored in the window corresponding to the first language into a translation model to obtain a second token of the second language. For example, the electronic apparatus 100 may input the first token corresponding to Korean into the translation model to obtain the second token corresponding to English.

For example, the second token may be represented by integer values of [532, 753, 2345, 28543, 23256]. The electronic apparatus 100 may store the obtained token [532, 753, 2345, 28543, 23256] in a second buffer.

The electronic apparatus 100 may identify whether some of the tokens included in the obtained second token match tokens already stored in the window corresponding to the second language. If it identifies that some of the tokens of the second token match, the electronic apparatus 100 may store the matched tokens in a third buffer.

In this case, the second buffer may store a plurality of tokens included in the second token, and the third buffer may store tokens identified as matched more than a preset number of times among the plurality of tokens stored in the second buffer.

The electronic apparatus 100 may convert the tokens identified as matched into text of the second language by using a decoder part of the translation model.

For example, as shown in FIG. 1, the electronic apparatus 100 may output the text “The king of Spain is Felipe VI” converted into the second language through a display (not shown) or a speaker (not shown).

After storing the tokens identified as matched in the third buffer as described above, the electronic apparatus 100 may update the window corresponding to the second language. Specifically, the electronic apparatus 100 may identify that the length of a plurality of tokens stored in the second buffer and the third buffer is longer than the length of the window corresponding to the second language. In this case, the electronic apparatus 100 may update (or shift to the right) the window corresponding to the second language by removing and storing a front portion of tokens among the plurality of tokens in the second token.

Meanwhile, for convenience of explanation, the translation model has been described based above on the assumption that it is a model based on a transformer structure. However, this is merely one embodiment, and the artificial neural network according to the present disclosure may include at least one of various types of neural network models, such as Convolution Neural Network (CNN), 1-Dimension Convolution Neural Network (1DCNN), Region with Convolution Neural Network (R-CNN), Region Proposal Network (RPN), Recurrent Neural Network (RNN), Stacking-based Deep Neural Network (S-DNN), State-Space Dynamic Neural Network (S-SDNN), Deconvolution Network, Deep Belief Network (DBN), Restricted Boltzmann Machine (RBM), Fully Convolutional Network, Long Short-Term Memory Network (LSTM), Bidirectional-Long Short-Term Memory Network (Bi-LSTM), Classification Network, Plain Residual Network, Dense Network, Hierarchical Pyramid Network, Squeeze and Excitation Network (SENet), Transformer Network, Encoder, Decoder, Auto Encoder, or a combination thereof, and is not limited to the above-mentioned examples.

In addition, for convenience of explanation, the following description is based on an embodiment in which the translation model is stored in memory 120 of the electronic apparatus 100, but this is merely one embodiment, and the translation model may of course be stored in an external apparatus.

According to the present disclosure, when translating text in the first language into text in the second language, the electronic apparatus 100 may update, in real time, a window corresponding to the first language and a window corresponding to the second language. Accordingly, the electronic apparatus 100 may provide translated text in real time.

Meanwhile, when text in the first language is input and text in the second language is output, any one of the following interfaces may be used: High Definition Multimedia Interface (HDMI), Mobile High-Definition Link (MHL), Universal Serial Bus (USB), Display Port (DP), Thunderbolt, Video Graphics Array port (VGA), RGB port, D-subminiature (D-SUB), or Digital Visual Interface (DVI). Depending on the implementation example, a port for input/output of only audio signals and a port for input/output of only video signals may be separately included, or a single port for input/output of both audio and video signals may be implemented. The electronic apparatus 100 may transmit at least one of audio or video signals to an external apparatus (e.g., an external display apparatus or an external speaker) using any one of the above-mentioned plurality of interfaces. In this case, an output port included in one of the plurality of interfaces may be connected to the external apparatus, and the electronic apparatus 100 may transmit at least one of audio data or image data to the external apparatus through the output port.

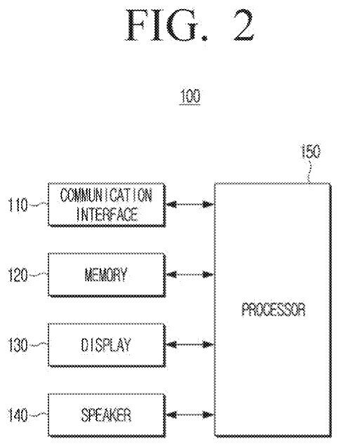

FIG. 2 is a block diagram provided to explain an electronic apparatus according to an embodiment. The configuration shown in FIG. 2 is merely one of various embodiments, and some components may be omitted, and new components may be added. As shown in FIG. 2, the electronic apparatus 100 may include the memory 120 and a processor 130. The configuration shown in FIG. 2 is merely one embodiment, and depending on the configuration of the electronic apparatus 100, some components may be deleted or added.

First, a communication interface 110 is configured to perform communication with various types of external apparatuses according to various types of communication methods. In particular, the communication interface 110 may transmit a feature value and a key value to a server apparatus 200. Alternatively, the communication interface 110 may receive a feature value and a key value from the server apparatus 200.

A wireless communication module may be a module that wirelessly performs communication with external apparatuses. For example, the wireless communication module may include at least one module among a Wi-Fi module, a Bluetooth module, an infrared communication module, an Ultra Wide-Band (UWB) module, or other types of communication modules.

Specifically, the wireless communication module may include at least one communication chip that performs communication according to various wireless communication standards such as Zigbee, Universal Serial Bus (USB), Mobile Industry Processor Interface Camera Serial Interface (MIPI CSI), 3rd Generation (3G), 3rd Generation Partnership Project (3GPP), Long Term Evolution (LTE), LTE Advanced (LTE-A), 4th Generation (4G), and 5th Generation (5G), in addition to the aforementioned communication methods. However, this is merely one embodiment, and the communication interface110 may utilize at least one communication module among various communication modules.

The wired communication module may be a module that performs communication with an external apparatus via a wired connection. For example, the wired communication module may include at least one of a Local Area Network (LAN) module, an Ethernet module, a pair cable, a coaxial cable, or an optical fiber cable.

According to an embodiment, the communication interface110 may utilize the same communication module (for example, a Wi-Fi module) to perform communication with external apparatuses such as a remote control device and an external server.

According to an embodiment, the communication interface110 may utilize different communication modules to perform communication with external apparatuses such as a remote control device and an external server. For example, the communication interface 110 may use at least one of an Ethernet module or a Wi-Fi module to perform communication with an external server, and may use a Bluetooth module to perform communication with an external apparatus such as a remote control device. However, this is merely one embodiment, and the communication interface 110 may utilize at least one communication module among various communication modules when performing communication with a plurality of external apparatuses or external servers.

The memory 120 may store an Operating System (OS) for controlling the overall operations of the components of the electronic apparatus 100, and instructions or data related to the components of the electronic apparatus 100. In particular, the memory 120 may store information on a window corresponding to a first language and a window corresponding to a second language. In addition, the memory 120 may store information on a method for updating the window corresponding to the first language and the window corresponding to the second language, as well as information on a first buffer, a second buffer, and a third buffer. The memory 120 may also store information on a method for determining some tokens of the second token of the second language, and may store a translation model.

The memory 120 may be implemented in various forms, such as volatile memory (e.g., dynamic RAM (DRAM), static RAM (SRAM), or synchronous dynamic RAM (SDRAM)), non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive, or solid state drive (SSD)).

The display 130 may display various types of information. In particular, the display 130 may display translated text.

The display 130 may be implemented in various forms of displays such as Liquid Crystal Display (LCD), Organic Light Emitting Diodes (OLED) display, or Plasma Display Panel (PDP). The display may include a driving circuit, backlight unit, etc., which may be implemented in forms such as amorphous silicon thin film transistor (a-si TFT), low temperature poly silicon TFT (LTPS TFT), or organic TFT (OTFT). The display may also be implemented as a touchscreen combined with a touch sensor, a flexible display, or a 3D display (three-dimensional display). According to various embodiments of the present disclosure, the display 130 may include not only a display panel that outputs images, but also a bezel that houses the display panel.

The speaker 140 is configured to output various types of audio data that have undergone processing such as decoding, amplification, and noise filtering, as well as various alert sounds or voice messages. In particular, the speaker 140 may output information related to events in audio form. In this case, the speaker 140 may be provided in plural on various areas of the electronic apparatus (for example, an upper area of the front surface or a lower side surface area of the electronic apparatus).

In particular, the speaker 140 may output a voice signal in a source language (or a first language), or convert and output text information in a target language (or a second language) into a voice signal.

The processor 120 may include one or more processors. Specifically, the one or more processors may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The processor 120 may control one or any combination of the other components of the electronic apparatus, and may perform communication-related operations or data processing. The one or more processors may execute one or more programs or instructions stored in the memory. For example, the one or more processors may perform a method according to an embodiment by executing one or more instructions stored in the memory.

The one or more processors may be implemented as a single core processor including a single core or as one or more multicore processors including a plurality of cores (e.g., homogeneous multicore or heterogeneous multicore). When the one or more processors are implemented as a multicore processor, each of the plurality of cores included in the multicore processor may include internal memory of the processor such as cache memory and an on-chip memory, and a common cache shared by the plurality of cores may be included in the multicore processor. In addition, each of the plurality of cores (or some of the plurality of cores) included in the multicore processor may independently read and perform program instructions to implement the method according to an embodiment, or all (or some) of the plurality of cores may be coupled to read and perform program instructions to implement the method according to an embodiment.

In particular, when first text of a first language is input, the processor 120 may obtain a first token corresponding to the language of the first text, store the first token in a window corresponding to the first language, update the window corresponding to the first language based on the length of the first token, input a plurality of tokens stored in the updated window corresponding to the first language into a translation model to obtain a second token of a second language, identify whether some of the second tokens of the second language match with a plurality of tokens previously stored in a window corresponding to the second language, and, based on the identification result, confirm some of the second tokens of the second language and update the window corresponding to the second language.

In addition, the processor 120 may obtain a first token corresponding to the input first text of the first language, update the window corresponding to the first language in which the first token is stored based on the length of the first token, and obtain a second token of a second language through an artificial intelligence model based on a plurality of tokens stored in the updated window corresponding to the first language. Further, when there is at least one token included in the obtained second token of the second language, which corresponds to a plurality of tokens previously stored in the window corresponding to the second language, the processor 120 may update the window corresponding to the second language based on the at least one token.

Further, the processor 120 may store the obtained first token in a first buffer, and may update the window corresponding to the first language, which identifies the number of stored tokens according to the first language, based on the number of tokens included in the first token.

When the length of the first token is longer than the length of the window corresponding to the first language, the processor 120 may update the window corresponding to the first language by storing a portion of the tokens included in the first token in the window corresponding to the first language. The processor 120 may remove tokens at the front portion of the first token, and update the window corresponding to the first language by storing added tokens among a plurality of tokens stored in the window corresponding to the first language.

The processor 120 may store the second token of the second language in a second buffer, and may identify whether a plurality of tokens included in the second token of the second language correspond to a plurality of tokens stored in the window corresponding to the second language a preset number of times or more.

The processor 120 may store at least one token included in the obtained second token of the second language in a third buffer.

When the length of the second token of the second language is longer than the length of the window corresponding to the second language, the processor 120 may update the window by removing a token having a higher priority among a plurality of tokens included in the second token. The window corresponding to the second language may store a plurality of tokens stored in the second buffer and the third buffer in which at least one token included in the obtained second token of the second language is stored.

The processor 120 may set the length of the window corresponding to the first language based on the first language, and may set the length of the window corresponding to the second language based on the second language.

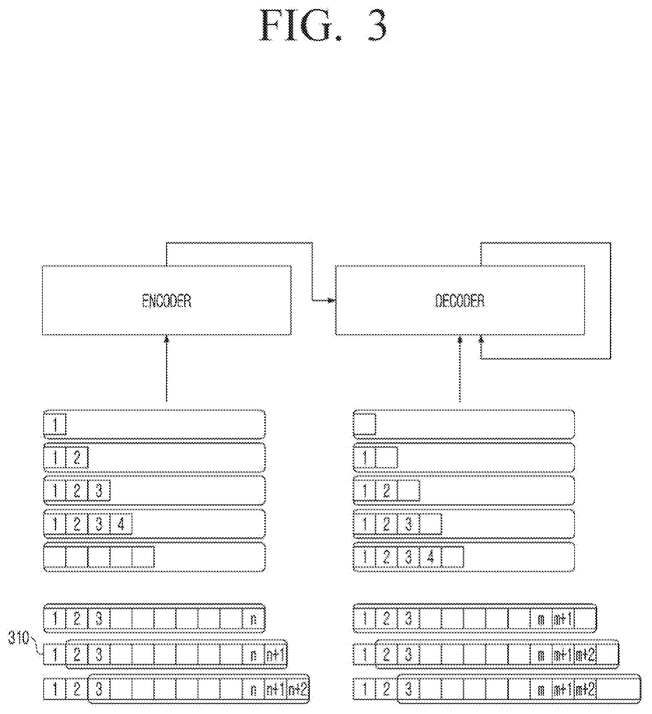

When it is identified that there is at least one token included in the obtained second token of the second language, which corresponds to a plurality of tokens previously stored in the window corresponding to the second language, the processor 120 may confirm at least one token. In addition, the processor 120 may update the window corresponding to the second language including the confirmed at least one token. Meanwhile, each of the above-described steps will be described hereinafter with reference to FIGS. 3 to 8.

FIG. 3 is a view provided to explain a process of performing a translation operation in real time using a window corresponding to a first language and a window corresponding to a second language according to an embodiment.

First, as illustrated in FIG. 3, when first text of the first language is input, the electronic apparatus 100 may obtain a first token corresponding to the language of the first text and store it in a window corresponding to the first language.

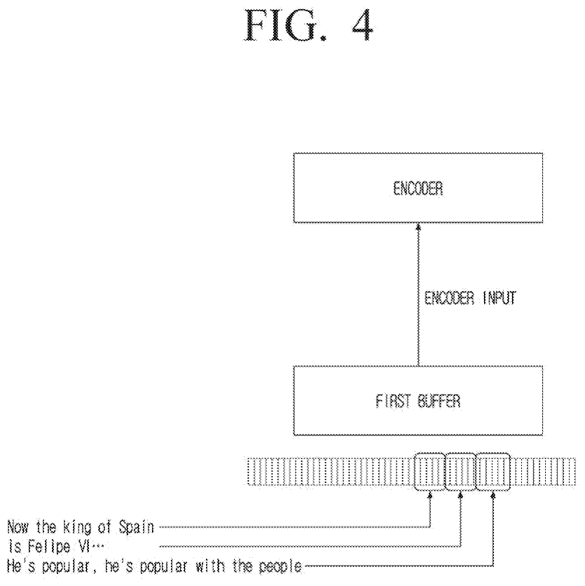

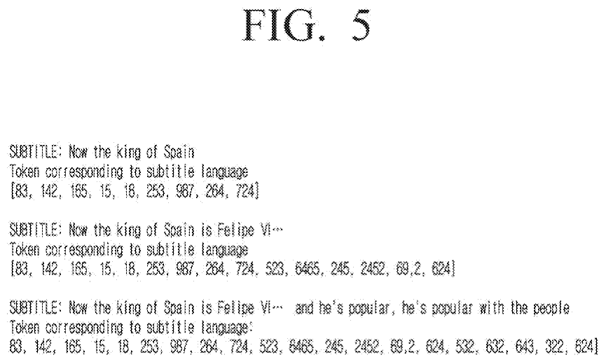

In this case, the electronic apparatus 100 may update the window corresponding to the first language based on the length of the first token. This will be described hereinafter with reference to FIGS. 4 and 5.

As illustrated in FIG. 4, the electronic apparatus 100 may obtain a first token corresponding to first text “Now the King of Spain.” In this case, as illustrated in FIG. 5, the electronic apparatus 100 may identify that a plurality of tokens corresponding to the text “Now the King of Spain” are [83, 142, 165, 15, 18, 253, 987, 264, 724].

The electronic apparatus 100 may store the obtained first token in a first buffer and in a window corresponding to the first language. When it is identified that the length of the first token is shorter than the length of the window corresponding to the first language, the electronic apparatus 100 may store the first token in the window corresponding to the first language to update the window.

Meanwhile, the electronic apparatus 100 may identify that the length of the obtained first token is longer than the length of the window corresponding to the first language. In this case, the electronic apparatus 100 may store the first token in the first buffer, and the window corresponding to the first language may set the number of tokens to be stored according to the first language and update the window corresponding to the first language based on the number of tokens included in the first token. In addition, when it is identified that the length of the first token is longer than the window of the source language (i.e., the window corresponding to the source language), the electronic apparatus 100 may update the window of the source language by storing a portion of the tokens of the first token in the window of the source language. When updating the window of the source language, the electronic apparatus 100 may remove tokens at the front portion of the first token and update the window by storing added tokens among the plurality of tokens stored in the window of the source language.

For example, the electronic apparatus 100 may obtain a first token corresponding to first text “called Felipe VI.” In addition, the electronic apparatus 100 may obtain the text “called Felipe VI” in the first language. In this case, the electronic apparatus 100 may identify that a plurality of tokens corresponding to the text “Now the King of Spain is called Felipe VI” are [83, 142, 165, 15, 18, 253, 987, 264, 724, 523, 6465, 245, 2452, 69, 2, 624].

The electronic apparatus 100 may identify that the length of the obtained first token is longer than the length of the window corresponding to the first language. In this case, the electronic apparatus 100 may remove a front portion of the tokens of the first language and store a rear portion of the tokens in the window corresponding to the first language.

For example, when the electronic apparatus 100 identifies that the length of [83, 142, 165, 15, 18, 253, 987, 264, 724, 523, 6465, 245, 2452, 69, 2, 624] is longer than the length of the window corresponding to the first language, the electronic apparatus 100 may remove the front tokens [83, 142, 165, 15, 18, 253, 987] and update the tokens [523, 6465, 245, 2452, 69, 2, 624].

The electronic apparatus 100 may obtain a second token corresponding to a second language after obtaining the first token. In this case, the electronic apparatus 100 may update the window corresponding to the second language using the second token, and may confirm some tokens among the second tokens of the second language.

Specifically, the electronic apparatus 100 may store the second token of the second language in a second buffer, and may identify that some of the second tokens of the second language and a plurality of tokens stored in the window of a target language match a preset number of times or more. In addition, the electronic apparatus 100 may store some of the identified second tokens of the second language in a third buffer. When it is identified that the length of the second token of the second language is greater than the size of the window of the target language, the electronic apparatus 100 may update the window by removing the token at the very front of the plurality of tokens included in the second token.

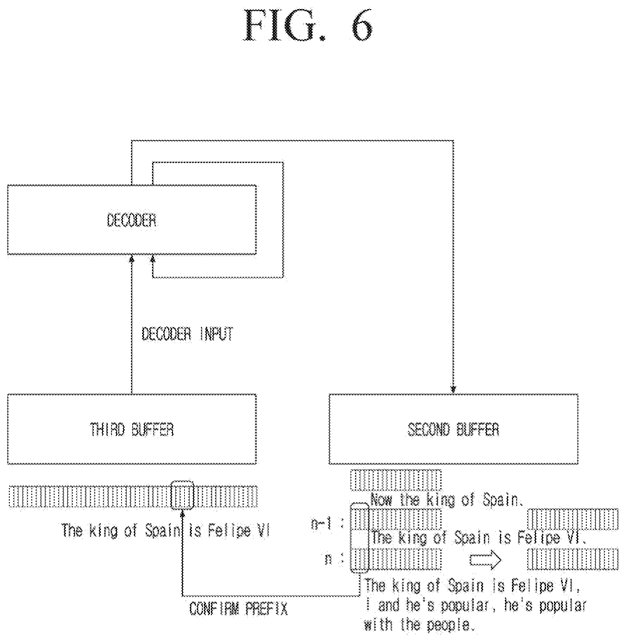

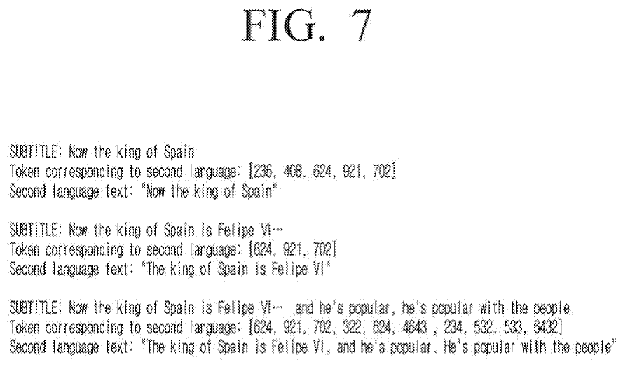

Specifically, the token at the very front of the plurality of tokens included in the second token may refer to a token having a high priority. Here, the “priority” may mean a degree of likelihood of being confirmed among the plurality of tokens included in the second token. In addition, the priority may mean a similarity value among tokens. This will be described hereinafter with reference to FIGS. 6 and 7.

The electronic apparatus 100 may confirm a token in a decoder included in a translation model using the obtained first token as described above with reference to FIGS. 4 and 5.

As illustrated in FIG. 6, the electronic apparatus 100 may store the second token of the second language in the second buffer. The second token may be a token corresponding to the text “The king of Spain is Felipe VI, and he's popular. He's popular with the people.” Specifically, as illustrated in FIG. 7, the second token may be [624, 921, 702, 322, 624, 4643, 234, 532, 533, 6432].

The electronic apparatus 100 may identify whether some of the second tokens of the second language match with a plurality of tokens previously stored in the second buffer.

For example, the electronic apparatus 100 may identify whether a plurality of tokens [624, 921, 702] stored in the second buffer and [624, 921, 702, 322, 624, 4643, 234, 532, 533, 6432] match. In this case, the electronic apparatus 100 may identify that [624, 921, 702] are matched.

In this case, the electronic apparatus 100 may store the plurality of tokens identified as matched in the third buffer. Specifically, the plurality of tokens identified as matched may be [624, 921, 702].

Meanwhile, for convenience of explanation, an embodiment has been described above in which, when some of the second tokens of the second language previously stored in the window and some of the second tokens of the second language match once, some of the second tokens identified as matched are confirmed. However, this is merely one embodiment, and for translation accuracy, it is of course possible to identify that some of the second tokens are confirmed when it is identified that they match two or more times.

After confirming some of the second tokens, the electronic apparatus 100 may identify whether the length of the tokens stored in the second buffer and the third buffer is longer than the window corresponding to the second language.

When the electronic apparatus 100 identifies that the length of the tokens stored in the second buffer and the third buffer is longer than the window corresponding to the second language, the electronic apparatus 100 may store some tokens among the plurality of tokens included in the second token in the window corresponding to the second language.

For example, the electronic apparatus 100 may update the window corresponding to the second language by removing the front portion of tokens [624, 921, 702, 532] among the second tokens [624, 921, 702, 322, 624, 4643, 234, 532, 533, 6432] and newly storing the rear portion of the tokens.

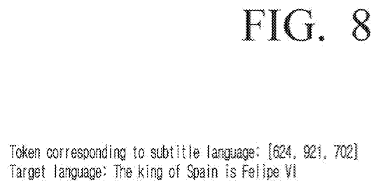

FIG. 8 is a view provided to explain an embodiment in which a plurality of tokens among the second tokens are confirmed and then output according to an embodiment.

As illustrated in FIG. 8, the electronic apparatus 100 may identify that the text of the second language (or target language) corresponding to the confirmed tokens [624, 921, 702] is “The king of Spain is Felipe VI,” and may output it through a display (not shown) or a speaker (not shown).

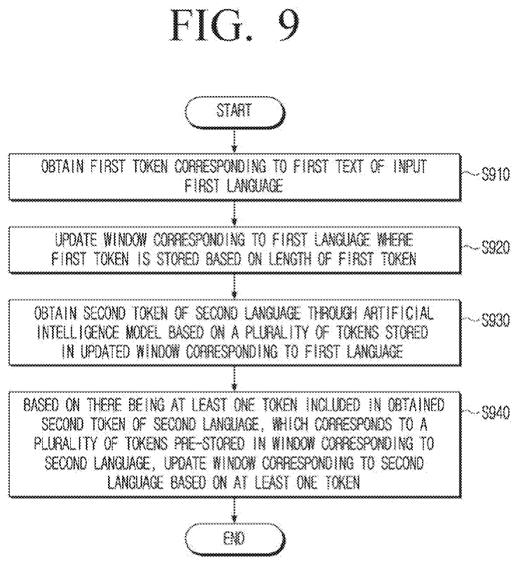

FIG. 9 is a flowchart provided to explain a method of controlling an electronic apparatus according to an embodiment.

The electronic apparatus 100 may obtain a first token corresponding to input first text of a first language (S910).

The electronic apparatus 100 may update the window corresponding to the first language in which the first token is stored based on the length of the first token (S920). Specifically, when the electronic apparatus 100 identifies that the length of the first token is shorter than the length of the window corresponding to the first language, the electronic apparatus 100 may store the first token without modification. On the other hand, when the electronic apparatus 100 identifies that the length of the first token is longer than the length of the window corresponding to the first language, the electronic apparatus 100 may store, in the window corresponding to the first language, the first token excluding a front portion and including a rear portion.

The electronic apparatus 100 may obtain a second token of the second language through an artificial intelligence model based on a plurality of tokens stored in the updated window corresponding to the first language (S930). In this case, the translation model may include a transformer structure, and since this has been previously described, a detailed description thereof will be omitted.

In addition, when there is at least one token included in the obtained second token of the second language, which corresponds to a plurality of tokens previously stored in the window corresponding to the second language, the electronic apparatus 100 may update the window corresponding to the second language based on the at least one token (S940).

Specifically, when some of the second tokens of the second language match with the plurality of tokens stored in the window corresponding to the second language, the electronic apparatus 100 may confirm some tokens among the identified second tokens of the second language. In addition, the electronic apparatus 100 may store some tokens identified as confirmed in the third buffer, and may store the unconfirmed tokens in the second buffer.

The electronic apparatus 100 may confirm some of the second tokens of the second language based on the identification result, and may update the window corresponding to the second language (i.e., the window of the target language or the window corresponding to the target language) (S950).

Specifically, when the electronic apparatus 100 identifies that the number of tokens of the second buffer and the third buffer is greater than the size of the window corresponding to the second language, the electronic apparatus 100 may remove the tokens at the front of the second buffer and the third buffer.

Further, the methods according to an embodiment may be included and provided in a computer program product. The computer program product may be traded as a product between a seller and a purchaser. The computer program product may be distributed in the form of a storage medium (e.g., compact disc read only memory (CD-ROM)) that is readable by devices, may be distributed through an application store (e.g., PlayStore™) or directly between two user devices 20 (e.g., smartphones), or may be distributed online (e.g., by downloading or uploading). In the case of an online distribution, at least part of the computer program product (e.g., a downloadable application) may be at least temporarily stored in a storage medium readable by a machine such as a server of the manufacturer, a server of an application store, or the memory of a relay server, or may be temporarily generated.

The methods according to various embodiments may be implemented as software including an instruction stored in machine-readable storage media, which can be read by machine (e.g.: computer). The machine refers to a device that calls instructions stored in a storage medium, and can operate according to the called instructions, and the device may include a server device or an electronic apparatus according to the aforementioned embodiments.

Meanwhile, the machine-readable storage medium may be provided in a form of a non-transitory storage medium. Here, the term ‘non-transitory’ means that the storage medium is tangible without including a signal (e.g., electromagnetic waves), and does not distinguish whether data are semi-permanently or temporarily stored in the storage medium. For example, a ‘non-transitory storage medium’ may include a buffer in which data is temporarily stored.

In case the instruction is executed by a processor, the processor may perform a function corresponding to the instruction by itself, or by using other components under its control. An instruction may include a code that is generated or executed by a compiler or an interpreter.

Although preferred embodiments of the present disclosure have been shown and described above, the disclosure is not limited to the specific embodiments described above, and various modifications may be made by one of ordinary skill in the art without departing from the spirit of the disclosure as claimed in the claims, and such modifications are not to be understood in isolation from the technical ideas or prospect of the disclosure.

| | | | |
|---|---|---|---|
| 100 | electronic apparatus | 110 | communication interface |
| 120 | memory | 130 | display |
| 140 | speaker | 150 | processor |

What is claimed is:

1. An electronic apparatus comprising:
a memory to store instructions; and
at least one processor to collectively or individually execute the instructions to cause the electronic apparatus to:
obtain a first token corresponding to a text of an input in a first language;
update a window corresponding to the first language where the first token is stored based on a length of the first token;
obtain a second token of a second language through an artificial intelligence model based on a plurality of tokens stored in a window corresponding to the updated window corresponding to the first language; and
based on at least one token included in the obtained second token of the second language, which corresponds to a plurality of tokens pre-stored in a window corresponding to the second language, update a window corresponding to the second language based on the at least one token.

2. The electronic apparatus as claimed in claim 1, wherein the at least one processor collectively or individually executes the instructions to cause the electronic apparatus to:
store the obtained first token in a first buffer; and
update the window corresponding to the first language, which identifies a number of stored tokens according to the first language, based on a number of tokens included in the first token.

3. The electronic apparatus as claimed in claim 2, wherein the at least one processor collectively or individually executes the instructions to cause the electronic apparatus to:
based on a length of the first token being longer than a length of the window corresponding to the first language, update the window corresponding to the first language is by storing a portion of tokens included in the first token in the window corresponding to the first language.

4. The electronic apparatus as claimed in claim 3, wherein the first token is among a plurality of tokens of the first language and the at least one processor collectively or individually executes the instructions to cause the electronic apparatus to:
remove a front portion of the plurality of tokens of the first language; and
update the window corresponding to the first language by storing added tokens among the plurality of tokens stored in the window corresponding to the first language.

5. The electronic apparatus as claimed in claim 1, wherein the second token is among a plurality of tokens of the second language and the at least one processor collectively or individually executes the instructions to cause the electronic apparatus to:
store the second token of the second language in a second buffer; and
identify whether the plurality of tokens of the second language correspond to a plurality of tokens stored in the window corresponding to the second language no less than a preset number of times.

6. The electronic apparatus as claimed in claim 5, wherein the at least one processor collectively or individually executes the instructions to cause the electronic apparatus to:
store at least one token included in the plurality of tokens of the second language in a third buffer.

7. The electronic apparatus as claimed in claim 1, wherein the second token is among a plurality of tokens of the second language and the at least one processor collectively or individually executes the instructions to cause the electronic apparatus to:
based on a length of the second token of the second language being longer than a length of the window corresponding to the second language, update the window by removing a token with a high priority among a plurality of tokens of the second language.

8. The electronic apparatus as claimed in claim 1, wherein the second token is among a plurality of tokens of the second language and the window corresponding to the second language has the plurality of tokens stored in a second buffer and a third buffer where at least one token among the plurality of tokens of the second language is stored.

9. The electronic apparatus as claimed in claim 1, wherein the at least one processor collectively or individually executes the instructions to cause the electronic apparatus to:
set a length of a window corresponding to the first language based on the first language; and
set a length of a window corresponding to the second language based on the second language.

10. The electronic apparatus as claimed in claim 1, wherein the at least one processor collectively or individually executes the instructions to cause the electronic apparatus to:
based on at least one token included in the obtained second token of the second language, which corresponds to a plurality of tokens pre-stored in the window corresponding to the second language, update the window corresponding to the second language including the obtained at least one token.

11. A method of controlling an electronic apparatus, the method comprising:
obtaining a first token corresponding to a text of an input in a first language;
updating a window corresponding to the first language where the first token is stored based on a length of the first token;
obtaining a second token of a second language through an artificial intelligence model based on a plurality of tokens stored in a window corresponding to the updated window corresponding to the first language; and
based on at least one token included in the obtained second token of the second language, which corresponds to a plurality of tokens pre-stored in a window corresponding to the second language, updating a window corresponding to the second language based on the at least one token.

12. The method as claimed in claim 11, comprising:
storing the obtained first token in a first buffer; and
updating a window corresponding to the first language, which identifies a number of stored tokens according to the first language, based on a number of tokens included in the first token.

13. The method as claimed in claim 12, comprising:
based on a length of the first token being longer than a length of the window corresponding to the first language, the window corresponding to the first language is updated by storing a portion of tokens included in the first token in the window corresponding to the first language.

14. The method as claimed in claim 13, wherein the first token is among a plurality of tokens of the first language and the method comprises:
removing a front portion of the plurality of tokens of the first language; and
updating the window corresponding to the first language by storing added tokens among the plurality of tokens stored in the window corresponding to the first language.

15. The method as claimed in claim 11, the second token is among a plurality of tokens of the second language and the method comprises:
storing the second token of the second language in a second buffer; and
identifying whether the plurality of tokens of the second language correspond to a plurality of tokens stored in the window corresponding to the second language no less than a preset number of times.
